(19) United States
(12) Patent Application Publication
(10) Pub. No.: US 2011/0185035 A1
(43) Pub. Date: Jul. 28, 2011

(54) Universal Remote Diagnostic Access Device for Medical Equipment and Method of Use

(76) Inventor: David Van, Jersey City, NJ (US)

(21) Appl. No.: 12/691,864

(22) Filed: Jan. 22, 2010

(51) Int. Cl. G06F 15/16; G06F 3/048; G06F 21/00

(52) U.S. Cl. 709/217; 709/250; 715/764; 726/3

(57) ABSTRACT

Embodiments of the disclosed technology comprise an intermediary device with an efficient methodology for providing secure remote access for medical equipment diagnostics. This device and method of use provides tools to enable proprietary and legacy medical equipment, including those without interoperability capabilities, to be available for maintenance and diagnostics, remotely. A remote technician can “reach in” via secure access to calibrate machine components, retrieve error logs, or upgrade configuration files—all of which can be achieved through an extensive set of functions that are agnostic to the brand, make, and model of the failing or diagnosed medical equipment.

### FIELD OF THE DISCLOSED TECHNOLOGY

The disclosed technology relates generally to interfacing hardware devices and, more specifically, to medical devices with proprietary interfaces.

### BACKGROUND OF THE DISCLOSED TECHNOLOGY

Medical equipment, such as ultrasounds, magnetic resonance imaging, X-ray equipment, and so forth, is used all over the world. However, skilled medical technicians are required to operate and maintain such pieces of equipment and, in many cases, maintenance must be carried out on site. This is problematic and costly in many instances. For a hospital in a suburban or rural area of even a fully developed nation, this might mean hours or days of downtime until a diagnostic technician can repair a machine in need of service. For an organization such as the United States Army, which has medical equipment deployed around the world, especially in war time, the problem is even more acute. Often, a technician must be flown from the United States to places such as Iraq or Afghanistan to fix, for example, an MRI machine near the battlefield. Doing so is reactive. The problem is only fixed after it has occurred.

The current medical equipment maintenance model, as described above, is on site and physical. There is neither a comprehensive nor a standardized interoperation protocol for medical technicians to troubleshoot and resolve problems. The lack of evidence to the state of repair of medical equipment and the need to be on site for problem resolution, coupled with frequent rotations and scarcity of equipment technicians, continue to cause considerable downtime of critical medical equipment densities and is detrimental to the health care support for our soldiers.

Specialized medical devices such as Magnetic Resonance Imaging (MRI), Computed Tomography (CT), Computed Radiology (CR) scanners, along with ultrasonic and laboratory devices are critical to the patients' diagnostic and treatment regimen. Unscheduled delays and/or extensive downtime of the equipment severely hamper the physicians' ability to diagnose and treat a patient's injury or medical condition. Complexity often requires the local maintainer to rely on external support or third party service providers, usually from the equipments' manufacturer, to assist in pinpointing the problem and repair. This “wait and see” method, coupled with the lack of any pre-screening capability to identify troubled areas, worn parts, or signal “out of tolerance” modalities can cause additional delays.

While medical equipment manufacturers offer variations of managed-services to monitor and maintain medical equipment in service for commercial installations, these offerings often can only support an individual manufacturer's own brand and model of medical equipment. Furthermore, their service model and the providers' infrastructures generally do not comply with U.S. and other government's security protocols and regulations. As a result, virtually all the offerings do not have the authority to operate (ATO) within the government networks due to the lack of accreditations and compliances. Compounding the problem is the fact that manufacturers are reluctant to release proprietary hardware and software specifications, access protocols, application programming interfaces (API), or software development kit (SDK) to allow independent development, integration, and support for off site maintenance in medical equipment operations.

Further, information technology solutions, such as virtual private networks, are generally unsuited to the specific proprietary hardware, software, and other requirements of medical devices. Ports used (e.g., 9-pin RS232, USB, Ethernet) vary, as do protocols, and are often proprietary to a specific manufacturer or device, and remote execution is often impossible with such systems.

In the prior art, the closest known mechanism to remedy this problem is essentially a method of teleconferencing for aircrafts and vehicles. This type of system is generally made up of a video camera, an audio device (microphone, speaker, or handset), a computer with pre-installed diagnostic software, a communication device for network connectivity (wired, WiFi, satellite link, etc.), and an optional battery for mobility. The system utilizes video for remote over-the-shoulder viewing during troubleshooting hardware failures, and the audio gears allow an untrained on-site local user to communicate with a remote technician. In practice, this system was found to be insufficient in the case of medical equipment. First, in many cases, medical equipment troubleshooting requires proprietary diagnostic software supplied by the equipment manufacturer; in addition, it must be capable of being run on the local maintainer's laptop. The software also requires a physical cable connecting the laptop to the medical equipment's console port. Since the software is very specific to the brand, model, and firmware versions of the medical equipment being diagnosed, the local maintainer must use the software that matches the hardware component to ensure compatibility. This means, if the teleconference system is used for medical equipment, the computer found in the system must have all the diagnostic software pre-installed, including several versions of the same software. Even if it is possible to pre-load all the diagnostic software from all the manufacturers into all the computers used, it is practically impossible to keep the versions of all software up-to-date on these systems.

Still further, connecting to multiple ports may be required, such as when trying to diagnose multiple machines. This means that it becomes difficult for even a physically present—let alone a teleconferencing—technician to diagnose several pieces of equipment simultaneously, or he cannot efficiently troubleshoot a complex piece of equipment with multiple console ports, such as the MRI.

Thus, a solution is needed allowing for more efficient maintenance of medical devices. A solution is also needed which will allow for proactive monitoring and diagnostics of a medical device. Even better would be a solution which allows for proactive monitoring of many medical devices.

### SUMMARY OF THE DISCLOSED TECHNOLOGY

It is therefore an object of the disclosed technology to provide a hardware device adapted to interface a specialized medical device with a remote hardware device.

It is a further object of the disclosed technology to maintain a specialized medical device from a remote location.

It is still a further object of the disclosed technology to maintain a plurality of specialized medical devices from a remote location.

An embodiment of the disclosed technology utilizes an intermediate hardware device comprising a plurality of input ports (e.g., RS-232 serial ports, video graphics array ports, RJ-45 network ports, universal serial bus ports, antenna receivers, and the like). At least one of the input ports of the plurality of input ports is engaged with a specialized medical device (e.g., magnetic resonance imaging machine, a computed tomography machine, a computed radiology scanner, an ultrasonic medical machine, etc.). An output port is engaged with a network which communicates data between the specialized medical device and a remote hardware device, where the remote hardware device is a device capable of performing maintenance (such as calibrating machine components, retrieving error logs, upgrade configurations, and the like) on the specialized medical device. Additionally, a matrix is adapted to interface the remote hardware device with a local interface of the specialized medical device.

The intermediate hardware device may interface with a plurality of specialized medical devices and the remote hardware device, in such a case, interfaces with each local user interface of a specialized medical device. Such a remote hardware device may be at a distance greater than 10 miles, or even 100 or 500 miles from the specialized medical device. Operation of the local user interface may require a direct electrical connection and the intermediate hardware device provides such a direct electrical connection in embodiments. That is, the interfacing may not function by way of another power source or powered device such as a router.

A security device may also be electrically connected to the remote hardware device and the local user interface detects the security device as being electrically connected to the specialized medical device. In such a case, the data between the security device (e.g., a USB key or dongle) and the specialized medical device is transferred via the intermediate hardware device.

The input ports of the intermediate hardware device may be any one of, or a plurality of, RS-232 serial ports (9 or 25 pin), video graphics array ports, digital video ports, RJ-45 network ports, universal serial bus ports, and antenna receivers. In a specific embodiment of the disclosed technology, the intermediate hardware device has at least one RS-232 serial port and at least one universal serial bus port, at least two specialized medical devices are electrically engaged via separate input ports of the intermediate hardware device, and a remote hardware device is configured to receive data input for manipulating each of the at least two specialized medical devices.

The remote hardware device may exhibit a graphical user interface. Such a graphical user interface may be a combined interface allowing for interaction with, or displaying parts or all of, an interface for multiple specialized medical devices.

Specialized medical devices of embodiments of the disclosed technology may be any one of a magnetic resonance imaging machine, a computed tomography machine, a computed radiology scanner, and a ultrasonic medical machine. Other specialized medical devices may also, of course, be used with the disclosed technology.

A method of hardware to hardware, in another embodiment of the disclosed technology, proceeds as follows. A multiple input-port intermediate hardware device is engaged with a specialized medical device via a direct electrical connection. A security device required to access the specialized medical device is engaged with a remote hardware device via a direct electrical connection. Data is communicated from the security device to the specialized medical device, and diagnostic data is received from the specialized medical device at the remote hardware device.

The remote hardware device may be used to perform maintenance on the specialized medical device via the multiple input-port intermediate hardware device. The specialized medical device might be a plurality of specialized medical devices. That is, the remote hardware device may be used to diagnose multiple medical devices. The remote hardware device might be a plurality of hardware devices.

The multiple input-port intermediate hardware device may provide a user interface with an interface for multiple specialized medical devices, such as a graphical user interface.

In a further method of the disclosed technology, the method is a method of interfacing with a specialized medical device designed to require a manufacturer-specific set of instructions to be sent and received via a proximate electrical connection (such as via a serial data connection [RS-232 or USB] or electrical dongle known in the art) between a hardware device and the specialized medical device. This is carried out by way of providing the proximate electrical connection between an intermediate hardware device and the specialized medical device. The intermediate hardware device forwards over a packet-switched network (such as the internet) a manufacturer-specific set of instructions to a remote hardware device. The remote hardware device executes code provided by the manufacturer and displays a user interface associated with the specialized medical device. The remote hardware device may be at least 10 miles from the specialized medical device.

Further details are set forth in the detailed description below.

### BRIEF DESCRIPTION OF THE DRAWINGS

FIG. 1A shows a prior art method of performing diagnostics on a specialized medical device.

FIG. 1B shows a method of performing diagnostics on a specialized medical device in embodiments of the disclosed technology.

FIG. 2 shows a high level block diagram of devices used to carry out embodiments of disclosed technology.

FIG. 3A shows network topology utilizing a specialized security device to gain access to a specialized medical device.

FIG. 3B shows network topology utilizing a specialized security device to gain access to a specialized medical device via an intermediary hardware device of embodiments of the disclosed technology.

FIG. 4 shows a method and devices used to interface between one of, or a plurality of, remote hardware devices and specialized medical devices in embodiments of the disclosed technology.

FIG. 5 shows input ports on an intermediary hardware device in an embodiment of the disclosed technology.

FIG. 6 shows an opposite side view of the intermediary hardware device of FIG. 5.

FIG. 7 shows a combined graphical user interface exhibited on a remote hardware device in an embodiment of the disclosed technology.

FIG. 8 shows a high level block diagram of devices which may be used to carry out embodiments of the disclosed technology.

### DETAILED DESCRIPTION OF EMBODIMENTS OF THE DISCLOSED TECHNOLOGY

Embodiments of the disclosed technology comprise a unified remote diagnostic access gateway which acts as an intermediary device with an efficient methodology for provisioning secure remote access for medical equipment diagnostics. These devices and method of use provide tools to enable proprietary and legacy medical equipment, including those without interoperability capabilities (capabilities for 3^{rd} party products to interact with the device), to be available for maintenance and diagnostics (viewing and/or changing settings on the device), remotely. The methodology provides technicians with the ability to remotely perform diagnostic tasks and resolve problems of physical constraints. With such a new capability, a local maintainer, that is, a local user, can collaborate with experts, such as medical technicians, via an “over the shoulder” view of the medical device. Alternatively, a remote technician can “reach in” via secure access to calibrate machine components, retrieve error logs, or upgrade configuration files—all of which can be achieved through an extensive set of functions that are agnostic to the brand, make, and model of the failing or diagnosed medical equipment.

Embodiments of the disclosed technology will become clearer in light of the following description of the figures.

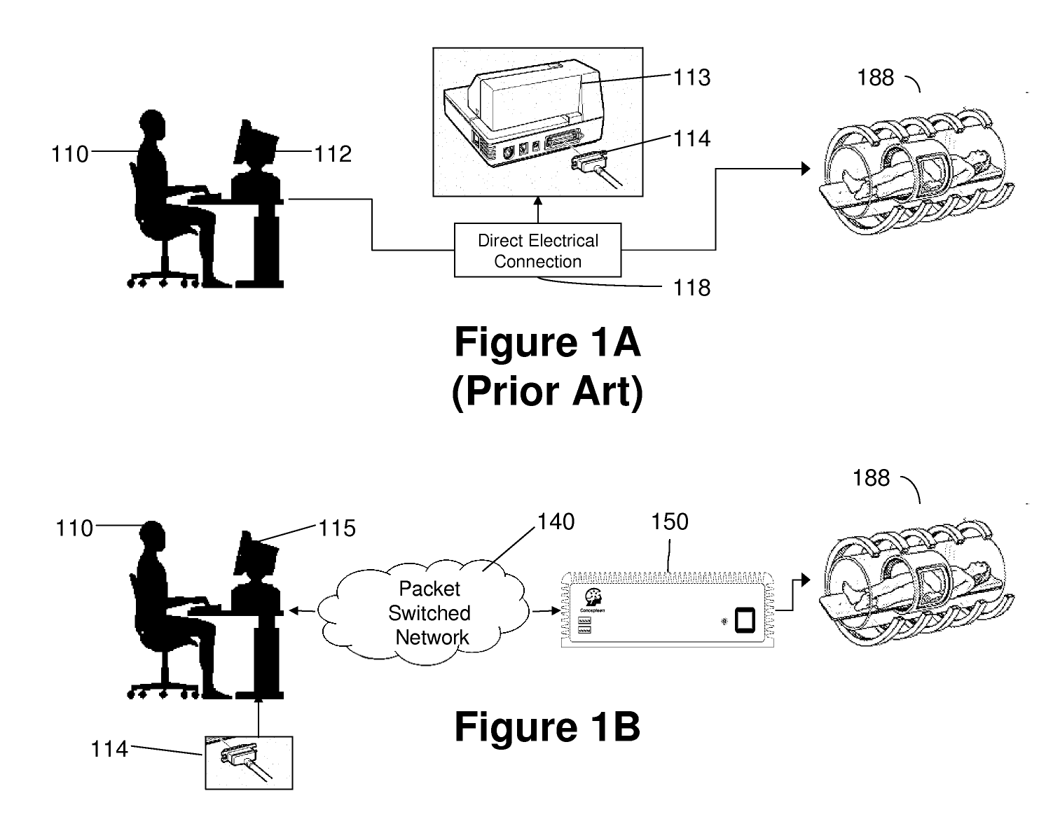

FIG. 1A shows a prior art method of performing diagnostics on a specialized medical device. A medical technician 110 may use a general purpose computer 112 and/or a specifically adapted hardware device 113 designed for diagnostic access with a specialized medical device 180. A security device 114 or other secure hardware device may be required to access the specialized medical device. The security device may be a dongle, hardware key, hardware token, or smart card/chip card with integrated circuits. Such devices are required for authentication and may be a piece of hardware with programmed circuitry required to pass through between the general purpose computer 112 and the specialized medical device, or required to be plugged into the specialized medical device in order to gain full access to the medical device. A medical technician 110, or other person trained, or having knowledge of how, to perform diagnostics or maintenance on specialized medical devices operates the general purpose computer 112 (or a specialized hardware device, such as one provided by the manufacturer and used to communicate with the medical device). The medical device, in this case, an MRI device 188, is designed by the manufacturer to require a direct electrical connection, such as via a serial, parallel, USB (universal serial bus), or other interface with either or both of the general purpose computer 112 and security device 114.

A direct electrical connection is defined as a connection where transmitted electrical pulses emitting from and received by the specialized medical device are received by and emitted from a hardware device used to access the specialized medical device. Examples of this include direct cable connections (e.g., a serial cable known in the art), wireless communication, and RFID. The direct electrical connection, as defined in the present disclosure, specifically excludes transmission of new electrical pulses, such as by way of routers and intermediate devices, e.g., over long distances. Another example, for purposes of this disclosure, which falls under the category of direct electrical connection, is that of the USB protocol and the like because, while a router may be used to retransmit a signal, the inherent design is such that the device is connected to a specific individual computer and is associated only with one computer or other hardware device at a time. As such, in the prior art method and devices of gaining diagnostic access to specialized medical devices, the medical technician 110 must be proximate (e.g., next to or in the vicinity of, defined as up to fifty feet maximum away from the medical device, a typical maximum length of a serial connection) to the specialized medical device to gain access. A hardware device 112 used by the medical technician in many cases must be loaded with proprietary software providing a proprietary interface for a specific medical device or a specific manufacturer's medical devices. Likewise, a specific medical device is often designed and sold by a manufacturer to work only with proprietary software and/or hardware provided by a manufacturer.

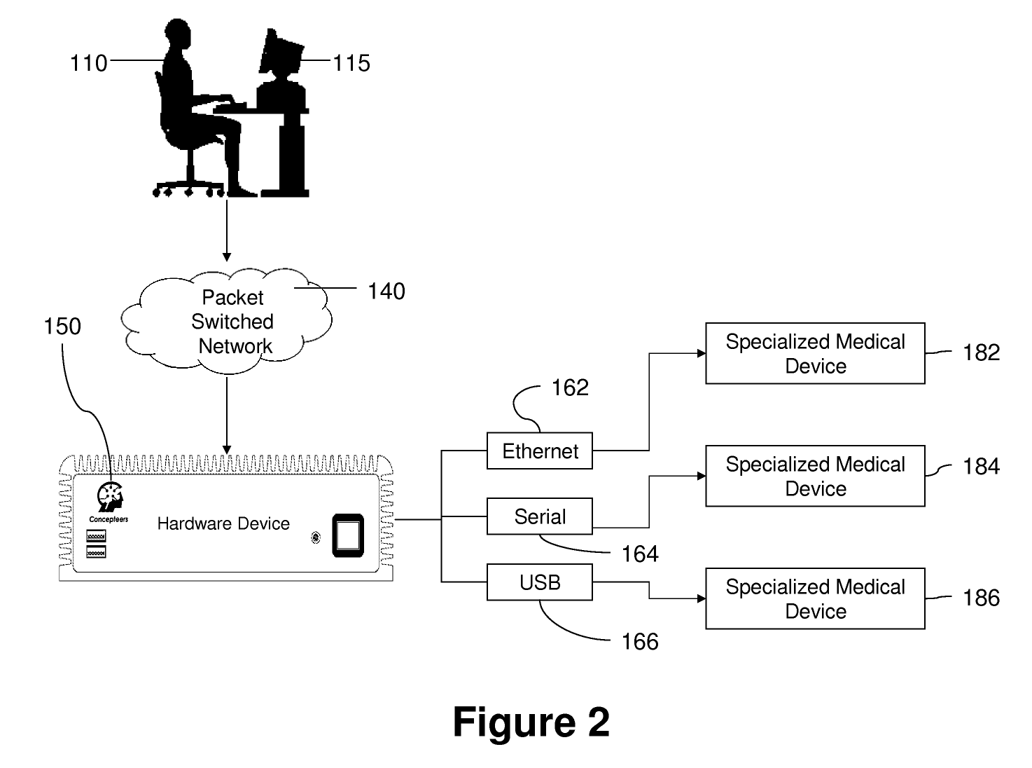

FIG. 1B shows a method of performing diagnostics on a specialized medical device in embodiments of the disclosed technology. Here, an intermediary hardware device 150 with a plurality of input and/or output ports provides a required direct electrical connection with the specialized medical device 188. Required, when referring to a direct electrical connection, is defined for purposes of this disclosure as meaning that a manufacturer of a specialized medical device has designed such a specialized medical device to work only with a specific hardware device, a hardware device loaded with a proprietary software from the manufacturer, and/or a security device (defined previously) which has a direct electrical connection with the specialized medical device. The intermediary device 150 provides the required connection with a medical device 188. An output port of the intermediary device, as will be shown and described in more detail with reference to FIG. 2, is a network port and a matrix (combination of hardware and/or software configuration within the intermediary device) which convert signals sent from a specialized medical device, such as device 188, via the direct electrical connection to packets as used in packet-switched networks, such as packet-switched network 140.

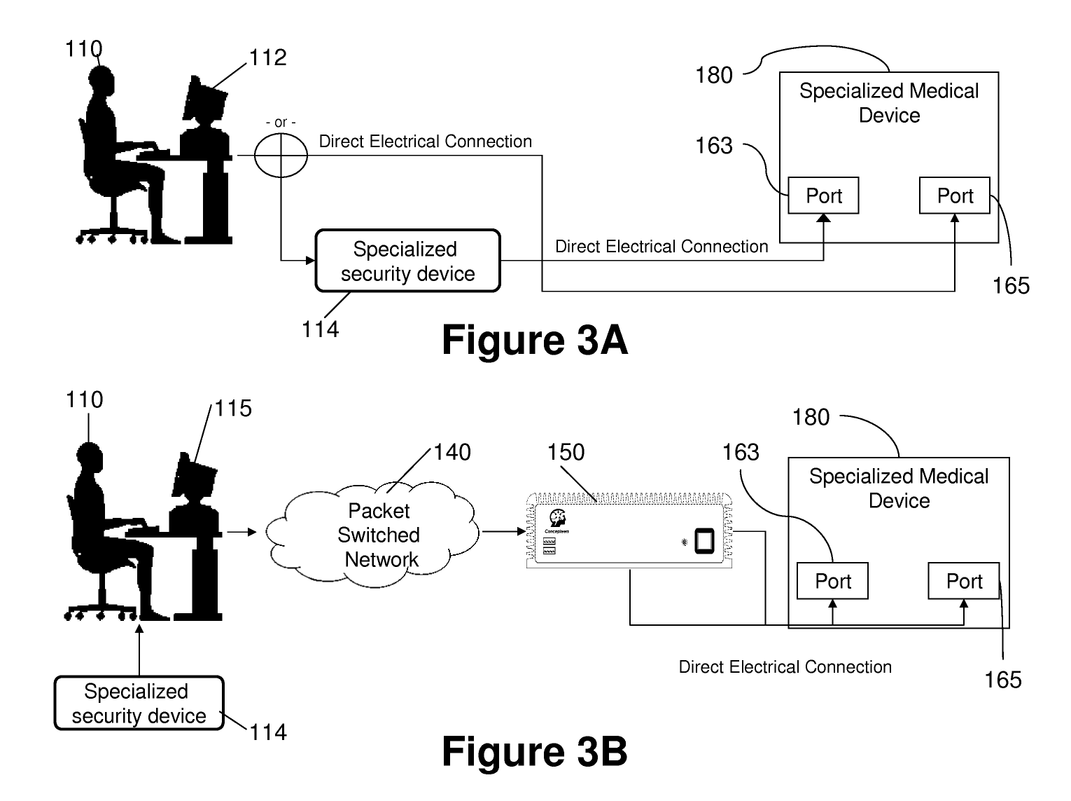

The network commonly known as “the internet” which comprises a world-wide network of computing devices interconnected via various switches and routers, is such a packet-switched network. Thus, at another location, such as in another vicinity greater than 10 miles away, greater than 100 miles away, or even across an ocean or on the other side of the globe, a medical technician 110 may access a remote hardware device 115, which may be a general purpose computer or a specialized hardware device provided by the manufacturer (as described with reference to FIG. 1A) and interact with the a specialized medical device. Further, in embodiments of the disclosed technology where a security device 114 is required to gain access to the specialized medical device, the security device may be interfaced (such as via a direct electrical connection) with the remote hardware device 115. Such an embodiment will be described in more detail with reference to FIG. 3.

FIG. 2 shows a high level block diagram of devices used to carry out embodiments of disclosed technology. A remote hardware device 115, such as a personal computer at a remote location, is used to access one or more specialized medical devices, 182, 184, and/or 186. A remote hardware device may have a display, network capabilities, and so forth, such as is shown and described with reference to FIG. 9. It may be a general purpose computer. Specialized medical devices (for instance Nos. 182, 184, and 186) are devices such as Magnetic Resonance Imaging (MRI), Computed Tomography (CT), Computed Radiology (CR) scanners, along with ultrasonic and laboratory devices. A specialized medical device is a device which is designed for the primary purpose of diagnosing medical problems and, for purposes of this disclosure, comprises at least one port enabling diagnostic access of the device, by way of utilizing a hardware device which is plugged into (has direct electrical connectivity with) the specialized medical device. The intermediary device comprises at least one or a plurality of ports designed for a direct connection with one or more specialized medical devices. For example, the intermediary device 150 may have an Ethernet (network) 162, serial (DB-9/DB-25) 164, and/or a USB connector 166. Via these connections, direct electrical connections are made and data which is sent to validate or authenticate the connection is sent via one or more of these interfaces to one or more specialized medical devices, by the intermediate device 150.

Authentication and other data communicated to a specialized medical device are captured by the remote hardware device 115 and forwarded over the packet-switched network 140 from a remote hardware device 115 to the intermediary device 150, which then, via a hardware and/or software based matrix of program instructions and/or circuitry, converts the data back into its original form and transmits it to a specialized medical device. In some cases, this may require a preliminary step of capturing transmitted data between a proximate hardware device and a specialized medical device in use as designed by the manufacturer of the specialized medical device, in order to ensure that the matrix functions properly. Thus, the intermediary device 150 becomes the interfacing piece of hardware with a specialized medical device. A matrix then converts data received from such a medical device into a form transmittable as packetized data and/or over a local or wide area network to a remote computing device 110. The software or hardware required by the manufacturer may now be located at or in the proximate location of the remote hardware device 115 which receives the data from the intermediate device 150. The process also occurs in reverse where sent data from the remote hardware device 115 is converted into packetized data and/or transmitted over a network and to the intermediary device 150 which then converts the data into a form required by the manufacturer of a specialized medical device, and sends the properly formatted data to the specialized medical device. As such, an interface executed on the remote hardware device and a specialized medical device interact as if there were a local (proximate and/or direct electrical) connection between devices.

FIG. 3A shows network topology utilizing a specialized security device to gain access to a specialized medical device. In such systems, the manufacturer of a specialized medical device 180 has designed the device with at least one port 163 for interfacing with a diagnostic tool, such as a hardware device 112. In a first embodiment thereof, a specialized security device 114 must be plugged into or interface with the port 163. When the term, “must” is used, this is defined as from the perspective of the manufacturer, that is, that it is designed in such a manner. In such a case, if one were to ask the manufacturer of the specialized medical device 180, the manufacturer would say verbally or in its technical support documentation that a specific specialized security device 114, usually provided by the manufacturer itself, must be plugged into a port 163 of the specialized medical device 180. In methods and devices of the disclosed technology, it should be obvious that the diagnostic operations are functional by plugging a security device into a system elsewhere, as described with reference to FIG. 3B.

Still referring to FIG. 3A, a proximate hardware device 112, such as a general purpose computer or hardware device designed for diagnostic access with the specialized medical device 180, may be plugged into the specialized security device. For example, parallel port dongles plug into parallel ports, and a hardware access device is then plugged into the dongle. The security device may be built into a dongle or cable or be a separate connector, such as a dual-headed connector adapted for engagement with a port 163 and cable, the cable engaged at another end with a hardware device 112. In another embodiment, the specialized security device is plugged into a first port 163, and a hardware device 112 is plugged into a second port 165 (via electrical connections or electrical engagement). Both are required to gain access. The port may be a card reader, RFID (radio frequency identification) port and the like. The specialized security device 114 may be a card with circuitry, a magnetic strip, and so forth.

FIG. 3B shows network topology utilizing a specialized security device to gain access to a specialized medical device via an intermediary hardware device of embodiments of the disclosed technology. In each of the above embodiments described with reference to FIG. 3A, by way of the intermediary hardware device 150 disclosed in embodiments of the disclosed technology, a user may gain diagnostic access to the specialized medical device 180 from a remote location. While the specialized security device 114 may be used via direct connection, such as with port 163, and the devices and method of use are otherwise similar to what has been shown and described with reference to FIG. 2, in another embodiment, specialized security device 114 interfaces with a remote hardware device 115. However, the specialized security device 114, in embodiments of the disclosed technology and as shown in FIG. 3B, is electrically connected or electrically interfaces with a remote hardware device 115.

In the embodiment shown in FIG. 3B, a specialized medical device 180 has at least two ports, 163 and 165. The intermediary device 150 interfaces with (e.g., provides a direct electrical connection with) each of these ports. Over a packet-switched network 140, data is received via ports 163, and 165 is manipulated and transmitted to remote hardware device 115, where it is reassembled, typically, in its original form. The specialized security device 114 is located, in this embodiment, in the vicinity of the remote hardware device 115 and may directly interface with the remote hardware device. For example, where port 165 is a USB port for a data connection and port 163 is a magnetic card reader or USB port for dongle, the data sent via each of these ports is transmitted to a remote hardware device 115. Here, two USB ports are again used. A medical technician 110 in possession of a USB dongle (security device 114) inserts such a dongle into a USB port of the remote hardware device 115, and data is captured and sent back over the packet-switched network 140, through the intermediary device 150, converted via a software or hardware set of instructions (matrix) back into its original form and transmitted into port 163. Likewise, a second USB port, in this example, on the remote hardware device 115 is used to send data to port 165, or, by way of emulation, a virtual USB port is created so that software or an interface provided by the manufacturer executed on the remote hardware device 115 “thinks” it is communicating directly with the specialized medical device 180. Where encryption is used, the encrypted data is sent as is, and the specialized medical device or user interface provided by the manufacturer conducts decryption operations. The data sent and received is recovered in its original form, in such embodiments of the disclosed technology, at the remote hardware device 115 and the specialized medical device 180.

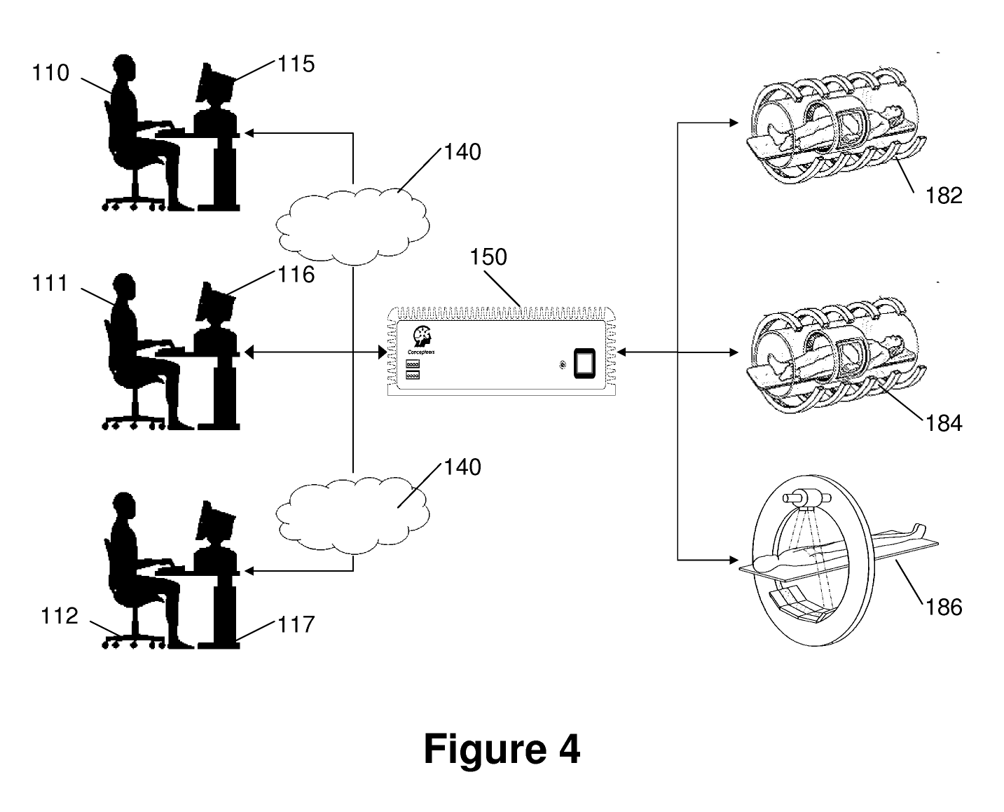

FIG. 4 shows a method and devices used to interface between one or a plurality of remote hardware devices and specialized medical devices in embodiments of the disclosed technology. A local technician 111 may insert a security device into his terminal 116, or directly into a medical device 182, 184, or 186. The user 111, or another technician 110 or 112, communicating to the intermediary device 150 by way of a network 140, may also access any one of the medical devices 182, 184, or 186. Users may be switched, as necessary, or multiple users may access a specific medical device concurrently or serially. Still further, a remote hardware device 115 or 117 may execute commands to gain access to a medical device 182, 184, or 186 at regular intervals to perform diagnostics (diagnostic access). That is, information may be received from one or more of the medical devices to determine whether certain data is out of bounds, or action is required maintain a specialized medical device in working order before a problem occurs. Further, the intermediate device 150 may provide a secondary interface for access to a plurality of medical devices simultaneously or via an interface other than that which is provided by the manufacturer. For example, medical device 182 may provide proprietary software which can only be executed on a specific platform. By way of the intermediary device 150, a local console executing such a proprietary interface may be utilized while the intermediary device 150 transmits a second interface, such as a graphical user interface to a remote hardware device, such as remote hardware device 115 via a website. Using a web interface, the remote technician 110 manipulates data in this second interface which is translated into manipulations of the proprietary interface, and, as a result, manipulations of configuration options or outputs from the medical device 182. In other embodiments, a remote user interacts directly with such a proprietary interface, and such an interface is executed on the remote hardware device, but the interface and the specialized device are unaware of the intermediary device, as the data transferred to each is as if a manufacturer-designed (direct) connection between the two were there.

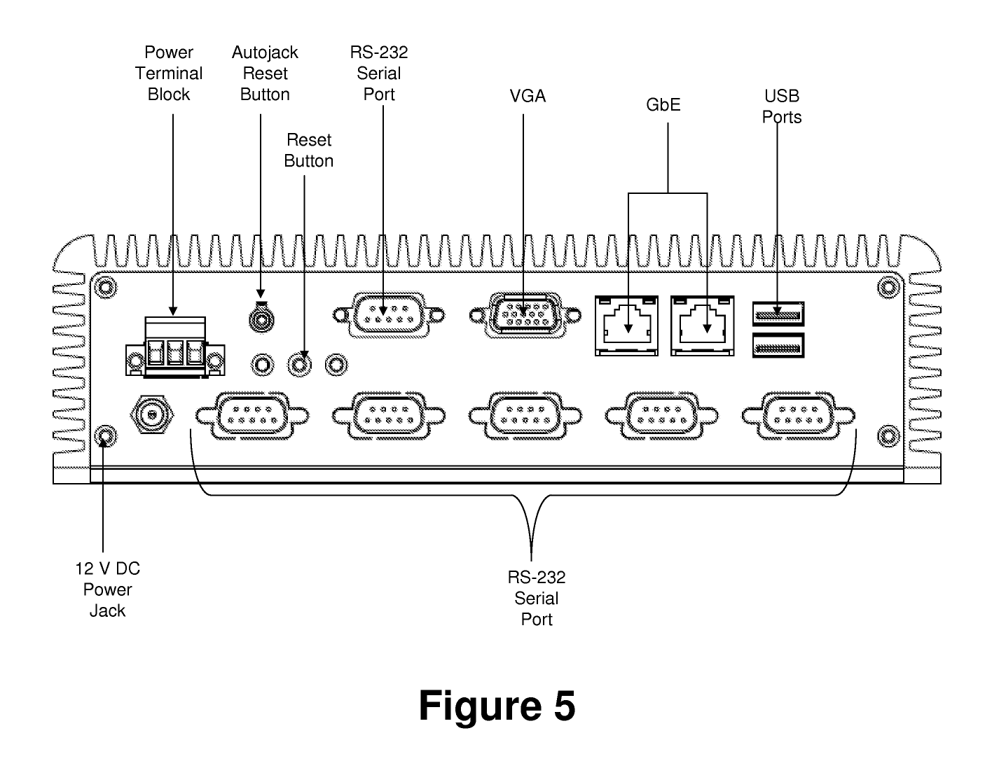

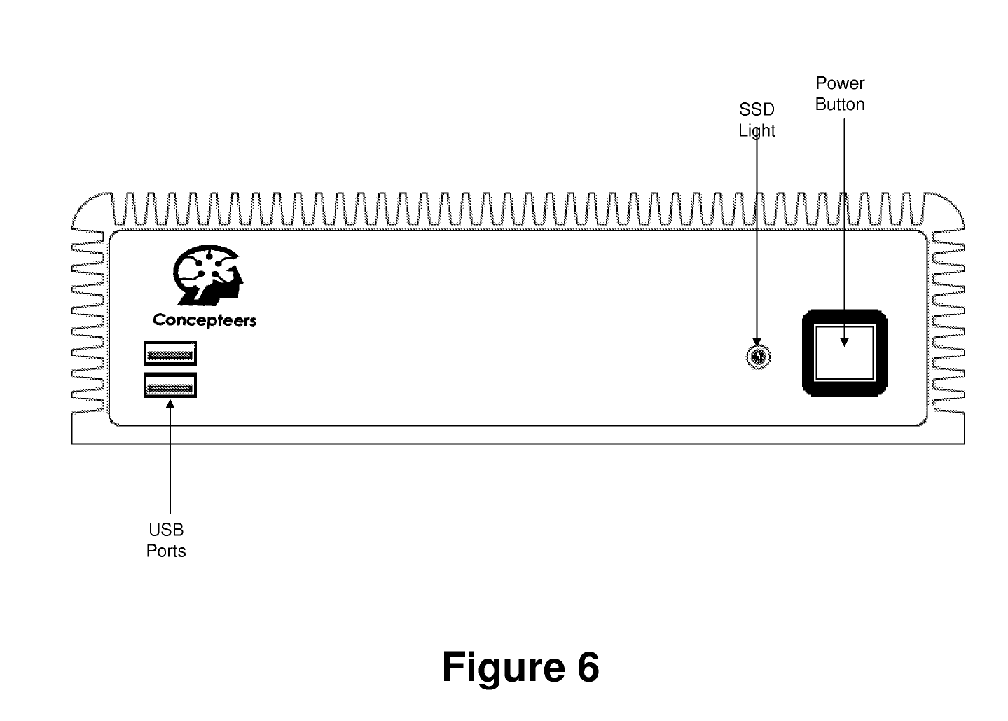

FIG. 5 shows input ports on an intermediary hardware device in an embodiment of the disclosed technology. FIG. 6 shows an opposite side view of the intermediary hardware device of FIG. 5. Such ports shown may be either input or output ports and connect to a specialized medical device or network. The intermediary device comprises hardware or software logic therein for converting data received via one port, such a serial port, to data for use over another type of port, such as a 100 base T network or the like. User login controls, an interface, and the like may be provided by the device, as is known in the art.

Describing now the ports of the embodiment of FIGS. 5 and 6, such ports comprise, for example, a power terminal block for powering a specialized medical device or the intermediary device, an autojack reset button for resetting a medical device via an electrical impulse external to a medical device, RS-232 serial ports, video ports (VGA), Ethernet ports (gigabit or 100 base T), USB ports, and so forth. Such a device may be designed with a specific form factor to fit specific applications.

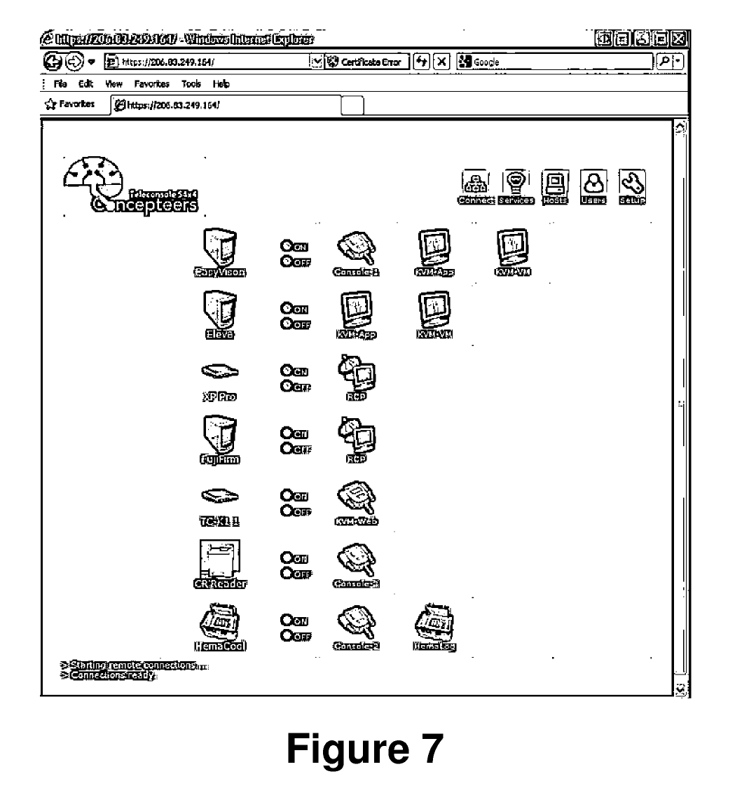

FIG. 7 shows a combined graphical user interface exhibited on a remote hardware device in an embodiment of the disclosed technology. Such an interface may be produced by the intermediary device, such as device 150 shown and described above and exhibited over a web interface. Individual ports on a remote device may be mapped to various medical devices. For example, a USB device, such as a security key, might be mapped to a specific medical device and the interface, turned on, so as to connect the USB device to the medical device, though the specialized medical device is elsewhere on the network, or elsewhere on the globe. A proprietary interface may then be executed on the remote device, via the USB interface, or proximate to the medical device and exhibiting on the remote device. Or, a secondary interface is provided on the remote device which interfaces with the proprietary interface.

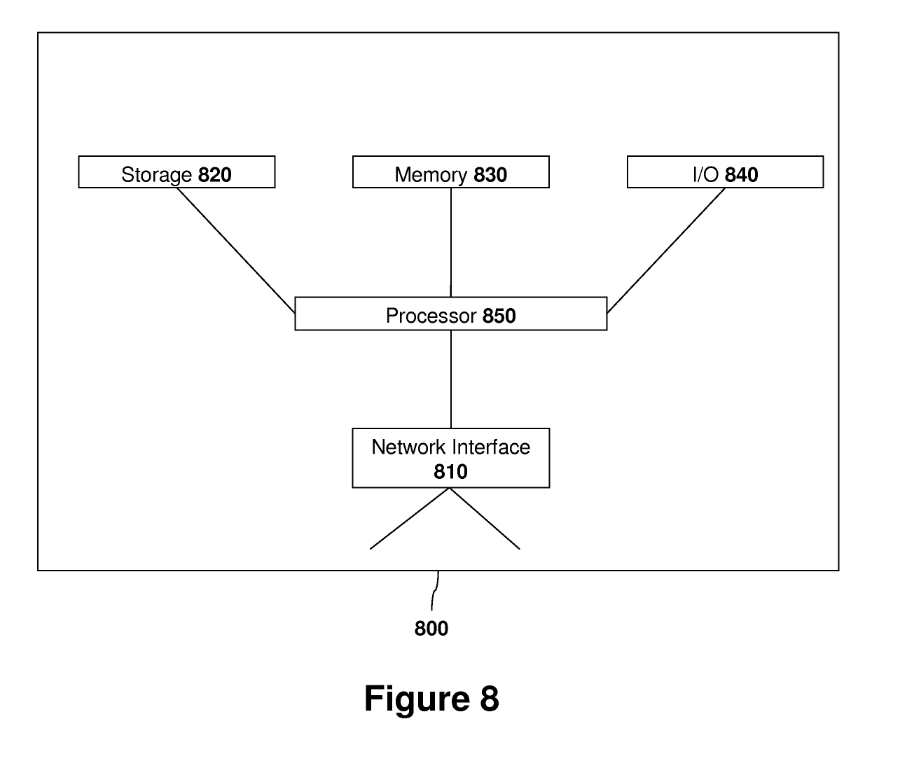

FIG. 8 shows a high-level block diagram of a device that may be used to carry out the disclosed technology. Device 800 comprises a processor 850 that controls the overall operation of the computer by executing the device's program instructions which define such operation. The device's program instructions may be stored in a storage device 820 (e.g., magnetic disk, database) and loaded into memory 830 when execution of the console's program instructions is desired. Thus, the device's operation will be defined by the device's program instructions stored in memory 830 and/or storage 820, and the console will be controlled by processor 850 executing the console's program instructions. A device 800 also includes one or a plurality of input network interfaces for communicating with other devices via a network (e.g., the internet). A device 800 also includes one or more output network interfaces 810 for communicating with other devices. Device 800 also includes input/output 840 representing devices which allow for user interaction with a computer (e.g., display, keyboard, mouse, speakers, buttons, etc.). One skilled in the art will recognize that an implementation of an actual device will contain other components as well, and that FIG. 8 is a high level representation of some of the components of such a device for illustrative purposes. It should also be understood by one skilled in the art that the method and devices depicted in FIGS. 1 through 7 may be implemented on a device such as is shown in FIG. 8.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

I claim:

1. An intermediate hardware device comprising:
a plurality of input ports, at least one input port of said plurality engaged with a specialized medical device;
an output port engaged with a network and communicating data between said specialized medical device and a remote hardware device via said network; and
a matrix adapted to interface said remote hardware device with a local user interface of said specialized medical device.

2. The intermediate hardware device of claim 1, where said remote hardware device interfaces with a plurality of specialized medical devices and said remote hardware device interfaces with each local user interface of a said specialized medical device.

3. The intermediate hardware device of claim 2, where said remote hardware device is at a distance greater than 10 miles from said specialized medical device.

4. The intermediate hardware device of claim 2, where operation of said local user interface requires a direct electrical connection and said intermediate hardware device provides said direct electrical connection.

5. The intermediate hardware device of claim 4, where a security device is electrically connected to said remote hardware device and said local user interface detects said security device as being electrically connected to said specialized medical device.

6. The intermediate hardware device of claim 4, where an input port of said plurality is selected from the group consisting of RS-232 serial ports, video graphics array ports, RJ-45 network ports, universal serial bus ports, and antenna receivers.

7. The intermediate hardware device of claim 4, where said plurality of input ports comprise at least one RS-232 serial port and at least one universal serial bus port;
at least two said specialized medical devices are electrically engaged with a separate said input port; and
a said remote hardware device is configured to receive data input for manipulating each of said at least two said specialized medical devices.

8. The intermediate hardware device of claim 7, where said remote hardware device exhibits a graphical user interface.

9. The intermediate hardware device of claim 8, where said graphical user interface is a combined interface comprising an interface for multiple specialized medical devices.

10. The intermediate hardware device of claim 1, where a specialized medical device of said plurality is selected from the group consisting of a magnetic resonance imaging machine, a computed tomography machine, a computed radiology scanner, and an ultrasonic medical machine.

11. A method of hardware to hardware emulation comprising:
engaging a multiple input-port intermediate hardware device with a specialized medical device via a direct electrical connection;
engaging a security device required to access said specialized medical device with a remote hardware device via a direct electrical connection;
communicating data from said security device to said specialized medical device; and
retrieving diagnostic data from said specialized medical device at said remote hardware device.

12. The method of claim 11, where said remote hardware device performs maintenance on said specialized medical device via said multiple input-port intermediate hardware device.

13. The method of claim 12, where said specialized medical device is a plurality of specialized medical devices.

14. The method of claim 13, where said remote hardware device is a plurality of hardware devices.

15. The method of claim 14, where said multiple input-port intermediate hardware device provides a user interface comprising an interface for multiple specialized medical devices.

16. The method of claim 15, where said user interface comprises a graphical user interface.

17. The method of claim 12, where an input port of said plurality is selected from the group consisting of RS-232 serial ports, video graphics array ports, RJ-45 network ports, universal serial bus ports, and antenna receivers.

18. The method of claim 12, where said specialized medical device is selected from the group consisting of magnetic resonance imaging, computed tomography, computed radiology scanners, and ultrasonic medical machinery.

19. A method of interfacing with a specialized medical device designed to require a manufacturer-specific set of instructions to be sent and received via a proximate electrical connection between a hardware device and said specialized medical device,
carried out by way of providing said proximate electrical connection between an intermediate hardware device and said specialized medical device,
said intermediate hardware device forwarding over a packet-switched network said manufacturer-specific set of instructions to a remote hardware device,
said remote hardware device executing code provided by said manufacturer and displaying a user interface associated with said specialized medical device.

20. The method of claim 19, wherein said remote hardware device is at least 10 miles from said specialized medical device.

21. The method of claim 20, wherein said proximate electrical connection is a serial or universal serial bus connection.
